(19) United States
(12) Patent Application Publication
(10) Pub. No.: US 2021/0220997 A1
(43) Pub. Date: Jul. 22, 2021

(54) INSPECTION APPARATUS AND METHOD FOR OBSERVING LEVEL OF CONSUMPTION OF CONSUMABLE ITEM

(71) Applicant: Preferred Networks, Inc., Tokyo (JP)

(72) Inventors: Yuya UNNO, Tokyo (JP); Kota NABESHIMA, Tokyo (JP); Hirochika ASAI, Tokyo (JP); Yusuke DOI, Tokyo (JP); Takeshi YOSHINO, Tokyo (JP)

(21) Appl. No.: 17/223,326

(22) Filed: Apr. 6, 2021

Related U.S. Application Data
(63) Continuation of application No. PCT/JP2019/036562, filed on Sep. 18, 2019.

(30) Foreign Application Priority Data
Oct. 15, 2018 (JP) 2018-194100

(51) Int. Cl. B25J 9/16; A47L 9/28; B25J 9/00; B25J 13/08; B25J 11/00

(52) U.S. Cl. CPC B25J 9/1679; A47L 9/2857; B25J 9/0003; B25J 9/1661; A47L 2201/06; B25J 13/089; B25J 9/1697; B25J 11/0085; B25J 9/1612

(57) ABSTRACT

An inspection apparatus includes one or more memories, and one or more processors. The one or more processors are configured to identify a first item as a target whose level of consumption is to be observed, and control a drive device to make the level of consumption of the first item, identified as the target, observable by an information acquisition device that observes the level of consumption of the target.

### CROSS-REFERENCE TO RELATED APPLICATIONS

This application is a continuation of International Application No. PCT/JP2019/036562, filed on Sep. 18, 2019 and designating the U.S., which claims priority to Japanese Patent Application No. 2018-194100, filed on Oct. 15, 2018. The contents of these applications are incorporated herein by reference in their entirety.

### BACKGROUND

### 1. Field of the Disclosure

The disclosures herein relate to an inspection apparatus and a method for observing the level of consumption of a consumable item.

### 2. Description of the Related Art

Various items are consumed and used in environments such as homes. In order to manage such items, a technology that determines the degree of degradation of food stored in a refrigerator is proposed. With this technology, the degree of degradation is determined by capturing an image of food with a camera installed in the refrigerator.

Further, if items in use are consumed, the items will be purchased in many cases. As a technology for purchasing such an item, a technology that allows the item to be purchased from an e-commerce site (what is known as an online shopping site) with one click of a physical or virtual button is known.

However, in order to determine the degree of degradation of an item, the camera needs to be installed in a place (such as a refrigerator) where the item is placed. Further, in the technology that allows an item to be purchased with one click, the level of consumption of the item needs to be managed by a human.

### SUMMARY

In view of the above, it is desirable to readily inspect the level of consumption of an item. Further, it is desirable to readily inspect the level of consumption of an item and take an action for the item in accordance with the inspection result.

According to an aspect of the present disclosure, an inspection apparatus includes one or more memories, and one or more processors. The one or more processors are configured to identify a first item as a target whose level of consumption is to be observed, and control a drive device to make the level of consumption of the first item, identified as the target, observable by an information acquisition device that observes the level of consumption of the target.

### BRIEF DESCRIPTION OF THE DRAWINGS

Other objects and further features of the present disclosure will be apparent from the following detailed description when read in conjunction with the accompanying drawings, in which:

FIG. 1 is a diagram illustrating an example of a use situation of a consumables inspection robot;

FIG. 2 is a diagram illustrating an example of an overall configuration of the consumables inspection robot according to an embodiment of the present disclosure;

FIG. 3 is a diagram illustrating an example of a hardware configuration of the consumables inspection robot according to an embodiment of the present disclosure;

FIG. 4 is a diagram illustrating an example of a functional configuration of the consumables inspection robot according to an embodiment of the present disclosure;

FIG. 5 is a diagram illustrating an example of consumable item information stored in a consumable item information storage unit; and

FIG. 6 is a flowchart illustrating an example of a consumable item inspecting process according to an embodiment of the present disclosure.

### DESCRIPTION OF THE EMBODIMENTS

According to at least one embodiment, the level of consumption of an item can be readily inspected. Further, the level of consumption of an item can be readily inspected and an action can be taken for the item in accordance with the inspection result.

In the following, embodiments of the present disclosure will be described in detail with reference to the accompanying drawings.

In an embodiment of the present disclosure, a consumables inspection robot 1, which is an example of an inspection apparatus, will be described. The consumables inspection robot 1 is autonomously movable, and is capable of inspecting the consumption level of a consumable item and replacing the consumable item or order a new consumable item in accordance with the inspection result.

In an embodiment of the present disclosure, consumable items are described as representing nondurable goods, such as beverages, food, cosmetics, light bulbs, detergents, clothing, toilet paper, stationery, and medicines, among items that are identified as targets whose levels of consumption are to be determined. Further, in an embodiment of the present disclosure, the consumable items are assumed to be for home use; however, the use of the consumable items are not limited to home use. The consumable items may be used in places outside the home, such as offices and factories. In particular, when the consumable items are used in offices and factories, the consumable items may include 3D printer filaments, screws, and various types of components. Further, an embodiment of the present disclosure may be suitably applied to durable goods such as furniture, fittings, and appliances, among items that are identified as targets whose levels of consumption are to be determined.

As used herein, the term “consumption” is not limited to a reduction in the quantity of an item, a stock shortage, and the like, and may be a condition in which an item malfunctions and any action needs to be taken. For example, the “consumption” may include damage, stains, malfunctions, and batteries going dead.

Further, as used herein, the expression “information acquisition device is movable” does not necessarily mean that the position of the information acquisition device itself is movable, and may mean that the information acquisition device is operable so as to acquire information by changing, for example, the zoom or tilt of a camera, with the fixed position of the information acquisition device unchanged.

### <Use Situation of Consumables Inspection Robot 1>

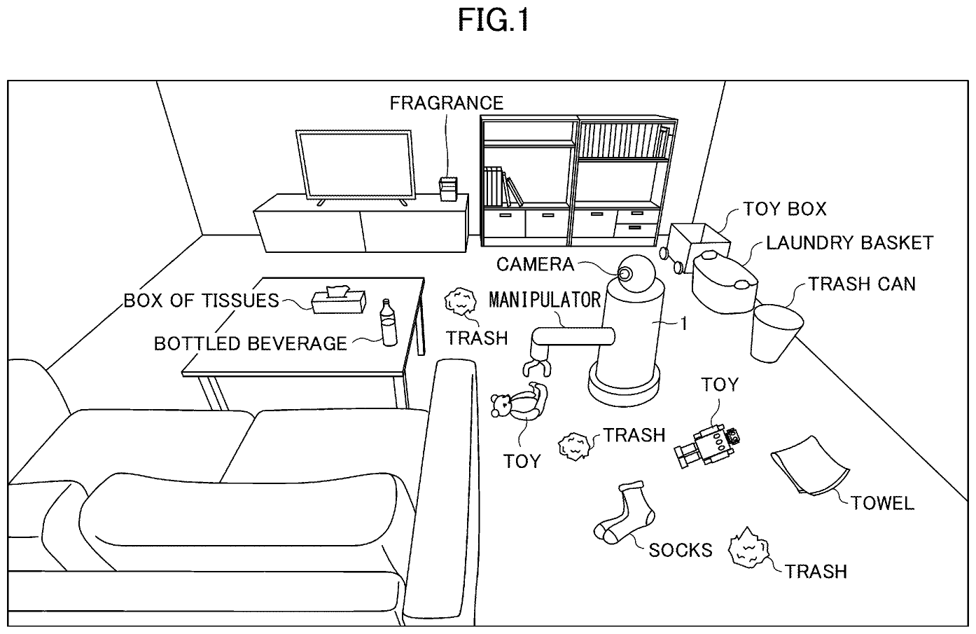

A use situation of the consumables inspection robot 1 according to an embodiment of the present disclosure will be described with reference to FIG. 1. FIG. 1 is a diagram illustrating an example of a use situation of the consumables inspection robot 1.

In the following, the consumables inspection robot 1 according to the embodiment of the present disclosure is a robot that is configured to organize and clean a room in a home, and also inspect consumable items while organizing and cleaning the room and send a notification, indicating that a consumable item needs to be replaced or ordered or is consumed, in accordance with the inspection result. That is, the consumables inspection robot 1 according to the embodiment of the present disclosure is configured to organize and clean a room in normal mode, and inspect the consumption levels of consumable items that are identified during operation in normal mode.

It would not be easy to inspect the consumption levels of various items consumed or used at home. However, according to the embodiment of the present disclosure, the consumption levels of various items can be readily inspected.

As illustrated in FIG. 1, it is assumed that various objects (such as “socks”, “trash”, a “towel”, and “toys”) are scattered in a room. In normal mode, the consumables inspection robot 1 detects an object with a camera and then grasps the object with a manipulator. Then, the consumables inspection robot 1 moves (arranges) the object to an appropriate location while autonomously moving. In this manner, the consumables inspection robot 1 organizes and cleans the room. For example, the consumables inspection robot 1 organizes and cleans the room by placing the “trash” in a trash can, the “socks” and the “towel” in a laundry basket, and the “toys” in a toy box.

In addition, if the consumables inspection robot 1 detects a pre-registered consumable item (such as a “box of tissues”, a “bottled beverage”, or a “fragrance”) with the camera, the consumables inspection robot 1 inspects the consumption level of the consumable item. Then, the consumables inspection robot 1 replaces the consumable item or orders a new consumable item in accordance with the inspection result. For example, if the “box of tissues” is empty (or if only a few tissues remain in the box), the consumables inspection robot 1 replaces the “box of tissues” with a new box of tissues stored as stock. Alternatively, if there is no stock, the consumables inspection robot 1 orders a box of tissues from a predetermined supplier. Similarly, if the “bottled beverage” or the “fragrance” is empty (or if there is only a small amount remaining), the consumables inspection robot 1 replaces the “bottled beverage” or the “fragrance” with a bottled beverage or a fragrance stored as stock. Alternatively, if there is no stock, the consumables inspection robot 1 orders a bottled beverage or a fragrance from a predetermined supplier.

Accordingly, if the consumables inspection robot 1 according to the embodiment of the present disclosure detects a pre-registered consumable item while organizing and cleaning the room in normal mode, the consumables inspection robot 1 inspects the consumable item (in the background of the normal mode operation or as an interruption to the normal mode operation). Therefore, a user is not required to selectively set a mode (either the normal mode or a consumables inspection mode, which will be described later) beforehand, or instruct to switch to another mode during the operation, which is advantageous for the user.

However, the present disclosure is not limited to the above-described example. For example, the consumables inspection robot 1 according to the embodiment of the present disclosure may include the “consumables inspection mode” separately from the normal mode, and the consumables inspection mode may function independently. In consumables inspection mode, the consumables inspection robot 1 performs inspections of consumable items only. In this case, because there is no need to switch between the modes, the speed and accuracy of inspections can be increased, as compared to when the consumables inspection robot 1 is operated in normal mode.

Alternatively, the consumables inspection robot 1 according to the embodiment of the present disclosure may be a robot that is configured to inspect consumable items without organizing or cleaning a room. Further, the above-described normal mode may be a mode in which the consumables inspection robot 1 not only organizes and cleans a room, but also performs housework (such as cooking and laundry), or may be a mode in which the consumables inspection robot 1 performs predetermined chores of the general household chores.

### <Overall Configuration of Consumables Inspection Robot 1>

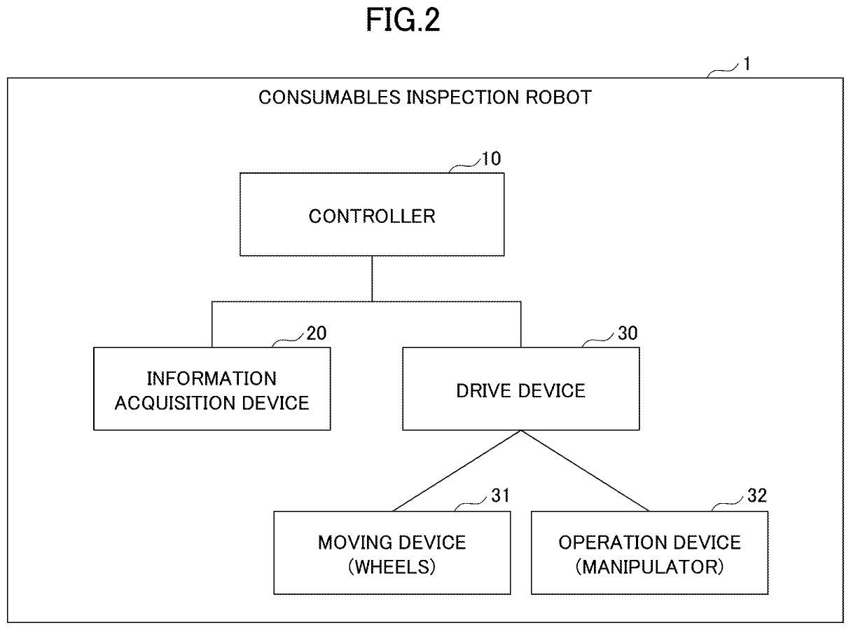

Next, an overall configuration of the consumables inspection robot 1 according to an embodiment of the present disclosure will be described with reference to FIG. 2. FIG. 2 is a diagram illustrating an example of an overall configuration of the consumables inspection robot 1 according to an embodiment of the present disclosure.

As illustrated in FIG. 2, the consumables inspection robot 1 according to the embodiment of the present disclosure includes a controller 10, an information acquisition device 20, and a drive device 30. Further, the consumables inspection robot 1 includes a moving device 31 (including wheels) that causes the consumables inspection robot 1 to be movable in cooperation with the drive device 30. The moving device 31 is an example of a moving device. Further, the consumables inspection robot 1 includes an operation device 32 (such as a manipulator), which is an example of an operation device. In the following, the moving device 31 may be referred to as “wheels 31”, and the operation device 32 may be referred to as a “manipulator 32”.

The controller 10 is a computer or computer system that controls the entire operation of the consumables inspection robot 1. By the controller 10 controlling the entire operation of the consumables inspection robot 1, the above-described normal mode and inspections of consumable items can be implemented.

The information acquisition device 20 may include a camera, a microphone, and any type of sensor. The information acquisition device 20 is equipment or a device configured to acquire various types of information, which is input into the controller 10. Acquiring various types of information may include receiving, generating, and collecting information. For example, the camera Produces an image by capturing the image within an angle of view. The camera may use a zoom lens to change the angle of view. The sensor acquires or collects information by sensing an object. The sensor may include a load sensor, such as a torque sensor and a 6-axis force sensor, disposed at each joint, the wrist, or the like of the manipulator 32, and a motion sensor that measures the movement of the consumables inspection robot 1. In addition, the sensor may also include an acceleration sensor, a temperature sensor, a tactile sensor, and a ranging sensor.

The drive device 30 is a device that causes the information acquisition device 20 to be movable. Specifically, the drive device 30 is equipment or a device configured to drive the wheels 31 and the manipulator 32. For example, the drive device 30 may include a motor disposed at each joint of the manipulator 32, a motor for changing the angle of view or the orientation of the camera, and a motor for rotating the wheels 31 disposed on the consumables inspection robot 1 so as to cause the consumables inspection robot 1 to be movable. In addition, the drive device 30 may include various motors and actuators.

The wheels 31 are a mechanism for moving the consumables inspection robot 1, and are an example of a moving device. In the embodiment of the present disclosure, the drive device 30 drives the motor for rotating the wheels 31 so as to cause the consumables inspection robot 1 to move. For example, if the consumables inspection robot 1 has feet (legs) in place of the wheels 31 or in addition to the wheels 31, the drive device 30 may drive actuators of the feet (legs) so as to the consumables inspection robot 1 to move. Further, the consumables inspection robot 1 may include a mechanism such as a propeller that allows the consumables inspection robot 1 to fly in the air, and a drive device 30 such as a motor that enables this mechanism.

The manipulator 32 is an example of an operation device. The operation device is a mechanism for physically making contact with an object (including an item, the same applies thereafter). For example, the operation device can physically grasp, move, tilt, rotate, apply pressure to, and strike an object with a degree of force. By including the operation device, the consumables inspection robot 1 can appropriately inspect the levels of consumption of various items, as will be discussed later. In particular, by including the operation device, the consumables inspection robot 1 can efficiently determine the levels of consumption of items at home where there may be a wide variety of items whose levels of consumption may be required to be determined by different methods. Further, in addition to making contact with an item to be inspected, the operation device may be used for other items. For example, the operation device can be used to open the door of a cabinet where items are stored. Accordingly, the consumables inspection robot 1 can more appropriately inspect the level of consumption of an item. Further, the operation device can also be used for operations such as replacing or disposing of an item or replenishing stock.

Further, the manipulator 32 may be referred to as a “manipulator arm”, a “manipulator hand”, a “robot arm”, a “robot hand”, or the like. The drive device 30 may include only one manipulator 32 or a plurality of manipulators 32. For example, the manipulator 32 may include a movable arm and an effector that is attached to the end of the arm.

### <Hardware Configuration of Consumables Inspection Robot 1>

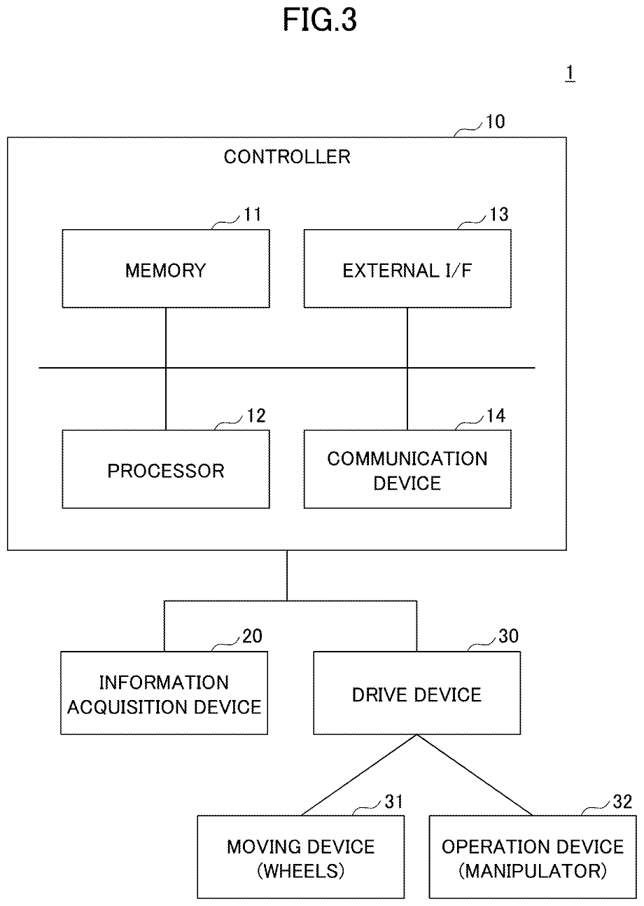

Next, a hardware configuration of the consumables inspection robot 1 according to an embodiment of the present disclosure will be described with reference to FIG. 3. FIG. 3 is a diagram illustrating an example of a hardware configuration of the consumables inspection robot 1 according to an embodiment of the present disclosure.

As illustrated in FIG. 3, the controller 10 of the consumables inspection robot 1 according to the embodiment of the present disclosure includes at least one memory 11 (or one or more memories 11), at least one processor 12 (or one or more processors 12), an external interface (I/F) 13, and a communication device 14 as hardware components.

The memory 11 is a storage device that stores various types of data and programs. The processor 12 may be, for example, an arithmetic unit such as a central processing unit (CPU), a graphics processing unit (GPU), or the like. The external I/F 13 is an interface with an external device (such as an external recording medium). The communication device 14 is equipment or a device for connecting to various networks such as the Internet.

The controller 10 of the consumables inspection robot 1 according to the embodiment of the present disclosure can use the hardware configuration illustrated in FIG. 3 to implement various processes as will be described later. Note that the hardware configuration illustrated in FIG. 3 is merely an example, and the controller 10 of the consumables inspection robot 1 may include any other hardware components. For example, the controller 10 of the consumables inspection robot 1 may include a plurality of processors 12. In addition, the consumables inspection robot 1 may include a speaker for outputting various sounds such as voice-based sounds, and a touch panel display for providing various user interfaces (UIs) to the user.

Further, functions of the consumables inspection robot 1 may be implemented by a plurality of computers, or may be implemented by a computer or a server via a network.

### <Functional Configuration of Consumables Inspection Robot 1>

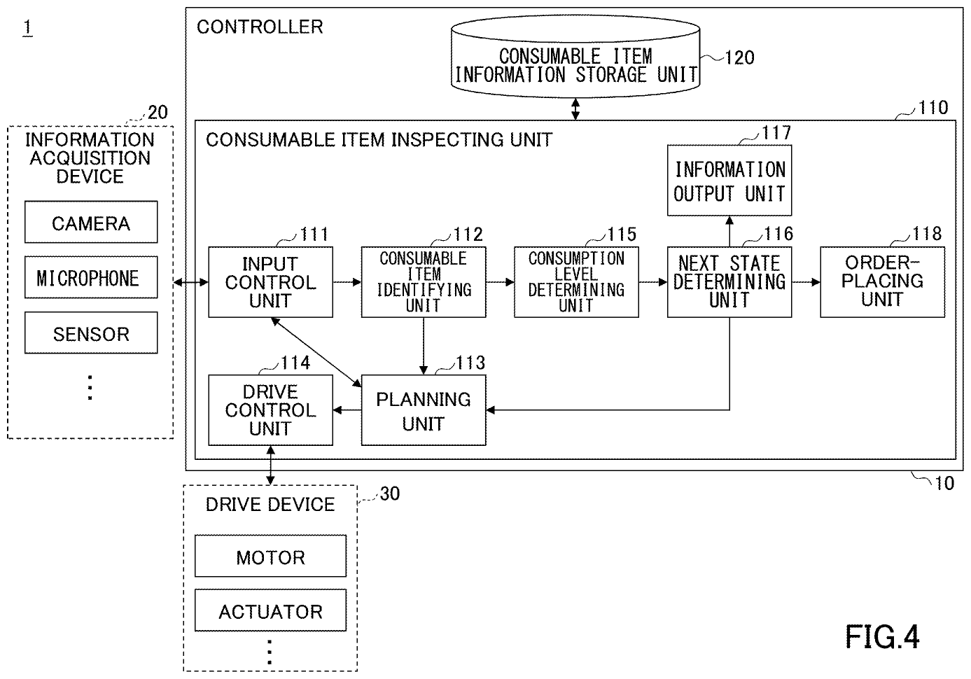

Next, a functional configuration of the consumables inspection robot 1 according to an embodiment of the present disclosure will be described with reference to FIG. 4. FIG. 4 is a diagram illustrating an example of a functional configuration of the consumables inspection robot 1 according to an embodiment of the present disclosure.

As illustrated in FIG. 4, the controller 10 of the consumables inspection robot 1 according to the embodiment of the present disclosure includes a consumable item inspecting unit 110 as a functional unit. The functional unit is implemented by the processor 12 by loading and executing one or more programs installed in the controller 10 (specifically, stored in the memory 11).

Further, the controller 10 of the consumables inspection robot 1 according to the embodiment of the present disclosure includes a consumable item information storage unit 120 as a storage unit. unit. The storage unit may be implemented by the memory 11.

The consumable item information storage unit 120 stores (registers) information related to each consumable item (hereinafter referred to as “consumable item information”). The consumable item information of each consumable item includes, for example, a method for inspecting (determining) the level of consumption (a “consumption level determining method” as will be described later). Details of the consumable item information of each consumable item will be described later.

The consumable item inspecting unit 110 performs a process for inspecting the level of consumption of a consumable item, and replacing the consumable item or supplying a new consumable item in accordance with the inspection result (hereinafter referred to as a “consumable item inspecting process”). The consumable item inspecting unit 110 includes an input control unit 111, a consumable item identifying unit 112, a planning unit 113, a drive control unit 114, a consumption level determining unit 115, a next state determining unit 116, an information output unit 117, and an order-placing unit 118 as functional units.

The input control unit 111 receives various types of information from the information acquisition device 20 as input information. For example, if the information acquisition device 20 is a camera, the input control unit 111 receives an image (including video) as input information. If the information acquisition device 20 is a microphone, the input control unit 111 receives sounds as input information. If the information acquisition device 20 is a sensor, the input control unit 111 receives various measurement values as input information.

Further, the input control unit 111 controls the information acquisition device 20 based on an action plan, which will be described later, made by the planning unit 113. By controlling the information acquisition device 20, an image is captured by the camera, sounds are collected by the microphone, and measurements (sensing) are performed by the sensor. Further, the input control unit 111 controls the angle of view of the camera. In addition, the input control unit 111 may control the pan, tilt, and zoom of the camera. That is, the input control unit 111 may control the information acquisition device 20 such that the information acquisition device 20 moves.

The consumable item identifying unit 112 identifies a consumable item (more specifically, an object that may be a consumable item) based on input information (an image captured by the camera in the embodiment of the present disclosure) received by the input control unit 111. The consumable item identifying unit 112 is an example of an identifying unit. The consumable item identifying unit 112 can use various types of methods to identify consumable items. For example, the identification of a consumable item may be performed by using a pre-trained classifier based on a Single Shot MultiBox Detector (SSD) or may be performed based on teaching data. Alternatively, the identification of a consumable item may be performed by a rule-based method, including detecting a barcode printed or attached to the consumable item or detecting characters on a package.

Identifying a consumable item by the consumable item identifying unit 112 includes identifying the consumable item itself and determining a consumable item class by a classifier integrated into the consumable item identifying unit 112. As a result, a consumable item ID that is identification information for identifying the consumable item, and a consumable item class ID that is identification information for identifying the consumable item class are output. The consumable item class is a class (classification) for identifying an action plan and a consumption level determining method, which will be described later. The type of class used as the consumable item class depends on the classifier. Details of the consumable item class will be described later.

The planning unit 113 first ascertains the current situation based on input information, received by the input control unit 111 (in particular, an image captured by the camera and a measurement value obtained by the sensor) and identification results obtained by the consumable item identifying unit 112. Then, the planning unit 113 refers to the consumable item information storage unit 120 and determines a plan (action plan) for the next action to be performed by the consumables inspection robot 1. Note that ascertaining the current situation means ascertaining the current distribution of consumable items within the angle of view of the camera, or understanding a consumable item ID of a consumable item grasped by the manipulator 32.

The action plan is a plan for an action (that is, a task) to be performed by the consumables inspection robot 1. Examples of specific plans for tasks include a rule-based plan, supervised machine learning, or an action plan based on a pre-trained reinforcement learning model. Various actions (tasks) are assumed to be performed by the consumables inspection robot 1. Examples of such actions (tasks) include grasping a consumable item, moving the consumable item, and capturing, with the camera, an image of the consumable item in order to determine the level of consumption of the consumable item.

The drive control unit 114 controls the drive device 30 based on an action plan determined by the planning unit 113. Controlling the drive device 30 causes the wheels 31 to be moved or the manipulator 32 to grasp a consumable item.

The consumption level determining unit 115, which is an example of a determining unit, determines the level of consumption of a consumable item. In the embodiment of the present disclosure, the consumption level determining unit 115 refers to the consumable item information storage unit 120, and determines the level of consumption of a consumable item (identified by the consumable item identifying unit 112) based on identification results obtained by the consumable item identifying unit 112. The level of consumption is information indicating the degree of consumption of the consumable item. For example, the remaining amount or the time remaining until the expiration date of the consumable item may be used. Examples of units used to describe the levels of consumption include amount, volume, quantity, classification based on given reference standards (such as a large quantity, a medium quantity, a small quantity), and an index value (such as an index value greater than or equal to 0 and less than or equal to 1) indicating that the degree of consumption increases as the value decreases. The unit to be used differs depending on the consumable item.

The next state determining unit 116 refers to the consumable item information storage unit 120, and determines the next state of a consumable item based on the determination result (the level of consumption) of the consumable item determined by the consumption level determining unit 115. As used herein, the “next state” is a flag that is set when, for example, the level of consumption of the consumable item is greater than or equal to a predetermined threshold. The flag indicates an appropriate action to be taken when the consumable item is consumed. Examples of such flags include a “placing a replenishment order” flag that indicates order placement for a new consumable item to replenish the consumable item, a “disposal and replacement” flag that indicates disposal of the consumable item and replacement with a new consumable item, and a “notification” flag that notifies the user that the consumable item is consumed. Note that the flags are not exclusive, and multiple flags may be turned on (set to “TRUE”) as the next state (for example, both the “placing a replenishment order” flag and the “disposal and replacement” flag may be set as the next state).

The information output unit 117 outputs predetermined information to the user of the consumables inspection robot 1. For example, if the next state of the consumable item is “disposal and replacement”, the information output unit 117 outputs information confirming whether to dispose of the consumable item. Further, if the next state is “placing a replenishment order”, the information output unit 117 outputs information confirming whether to order a new consumable item. Note that the information output unit 117 may output predetermined information to any destination in any way. For example, if the consumables inspection robot 1 is equipped with a display, information may be displayed on the display. Alternatively, information may be sent to a smartphone of the user via email. Note that the user may set what kind of information is output and where the information is displayed.

If the next state determined by the next state determining unit 116 is “placing a replenishment order”, the order-placing unit 118 order a new consumable item from a predetermined supplier (an e-commerce site).

Although not illustrated, the controller 10 of the consumables inspection robot 1 includes, as a functional unit, a processing unit (such as a normal mode processing unit) that causes the consumables inspection robot 1 to be operated in normal mode described above. The controller 10 of the consumables inspection robot 1 further includes a storage unit that stores information necessary for the consumables inspection robot 1 to be operated in normal mode.

Further, some of the above-described functional units may be implemented by an external service or a server connected to the controller 10 via a network. For example, an application Programming interface (API) provided by an external service may be used to implement some of the above-described functional units. Accordingly, the functions (units) of the controller 10 may be implemented by being distributed via a network.

### <Consumable Item Information>

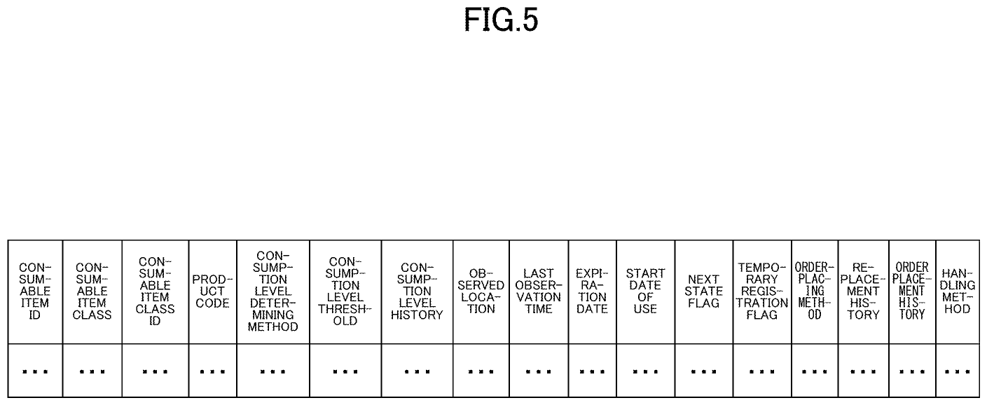

Next, the consumable item information of each consumable item stored in the consumable item information storage unit 120 will be described with reference to FIG. 5. FIG. 5 is a diagram illustrating an example of consumable item information stored in the consumable item information storage unit 120. For example, when the consumables inspection robot 1 detects a consumable item (article), consumable item information of the consumable item is temporarily registered. The consumable item information of the consumable item is then stored (registered) in the consumable item information storage unit 120 upon a registration operation being performed by the user. However, the present disclosure is not limited thereto, and the consumable item information may be registered upon the consumable item being detected by the consumables inspection robot 1 or any other device, or may be registered manually by the user.

As illustrated in FIG. 5, the consumable item information of each consumable item stored in the consumable item information storage unit 120 according to the embodiment of the present disclosure includes items (attributes or fields) such as a “consumable item ID”, a “consumable item class”, a “consumable item class ID”, a “product code”, a “consumption level determining method”, a “consumption level threshold”, a “consumption level history”, an “observed location”, a “last observation time”, an “expiration date”, a “start date of use”, a “next state flag”, a “temporary registration flag”, an “order-placing method”, a “replacement history”, an “order placement history”, and a “handling method”.

The “consumable item ID” indicates identification information for identifying a consumable item, as described above. For example, if there are two consumable items of the same type, the two consumable items have different consumable item IDs.

The “consumable item class” is a class to which the consumable item belongs. As described above, the types of classes used as consumable item classes depend on a classifier integrated into the consumable item identifying unit 112. As an example, the class to which the consumable item belongs may be represented by a combination of characteristics of the consumable item and a category of the consumable item. Examples of the characteristics of the consumable item include a “quantity-based consumable item” that is consumed or used as a single item (such as a rag or a sponge), an “amount-based consumable item” that is consumed or used in an amount (such as rice, a detergent, or a bottled beverage), and a “stock consumable item” that is managed in units (such as a box of bottled beverages). Examples of the category of the consumable item include rice, vegetables, meat, bottled beverages, sponges, cosmetics, seasonings, toilet paper, and boxes of tissues.

For example, the “consumable item class” may indicate a “amount-based consumable item, bottled beverage” or a “quantity-based consumable item, sponge”. Examples of the bottled beverage of the “amount-based consumable item, bottled beverage” include bottled green tea, bottled water, and bottled soda water. The “consumable item class” can be determined based on a product model (such as “green tea ΔΔ manufactured by Company A”).

There may be a case where a consumable item is either a quantity-based consumable item or an amount-based consumable item, and is also a stock consumable item at the same time. For example, if the content of a bottled beverage is almost empty (that is, if the level of consumption falls below a threshold), a stock bottled beverage is placed next to the bottled beverage that is almost empty. In this case, the bottled beverage is an amount-based consumable item and is also a stock consumable item at the same time. For such a consumable item that is either a quantity-based consumable item or an amount-based consumable item, and is also a stock consumable item at the same time, if the number of stocks falls below a threshold, the consumable item may be ordered.

The “consumable item class ID” is identification information for identifying the consumable item class. The “product code” is a code (such as a Japanese Article Number (JAN) barcode or a GSI barcode) for identifying the product name of the consumable item. The “consumption level determining method” is a method for determining the level of consumption of the consumable item. For example, the “consumption level determining method” is determined in accordance with the “consumable item class ID”. Examples of the “consumption level determining method” include visual inspection and weight inspection. Further, the visual inspection may include detailed rules indicating whether the consumable item is to be grasped by the manipulator 32, whether a reduction in amount is to be inspected, and whether deterioration in quality is to be inspected. If there is an inspection method specific to the consumable item, the inspection method (or an ID for identifying the inspection method) may be indicated.

The “consumption level threshold” is a threshold that is compared to the level of consumption of the consumable item. If the level of consumption of the consumable item falls below the threshold, “placing a replenishment order” or “disposal and replacement” is set as the next state of the consumable item.

The “consumption level history” is the history of the past levels of consumption of the consumable item (such as the dates and times when the level of consumption is inspected, and the inspection results).

The “observed location” is the history of locations at which the consumable item is observed. The locations of the consumable item are observed with respect to the location of the consumables inspection robot 1 estimated with simultaneous localization and mapping (SLAM). For example, even if a plurality of consumable items belonging to the same consumable item class are present in the same area (for example, if bars of soap of the same kind are used in a kitchen sink and in a bathroom sink), and also the consumable item IDs of the consumable items are difficult to be identified, the consumables inspection robot 1 can identify each of the consumable items. For example, the consumables inspection robot 1 can identify the bars of soap in the kitchen sink and in the bathroom sink by comparing the observed locations of the bars of soap to the last observed locations stored in the consumable item information storage unit 120.

The “last observation time” is the time or date when the location of the consumable item is last observed. The “expiration date” is the expiration date (including the shelf date and the best before date) of the consumable item. What type of expiration date is used may differ depends on the consumable item. If the consumable item is a food or a beverage, the expiration date or the best before date may be used. If the consumable item is a medicine or a safety product (such as a fire extinguisher), the expiration date or the shelf date may be used.

The “start date of use” is the date or date and time when the consumable item starts to be used. The “next state flag” is a set of values of flags (such as “placing a replenishment order” and “disposal and replacement”). The “temporary registration flag” is a flag indicating whether the consumable item is a temporarily registered item. For example, if the consumable item is detected by the consumables inspection robot 1, but is not yet registered by the user, the “temporary registration flag” is turned on.

The “order-placing method” is an example of a method for implementing an action taken when the consumable item is determined to be consumed. That is, the “order-placing method” is a method for ordering the consumable item if the action is order placement. The order-placing method includes supplier information (such as the uniform resource locator (URL) of a web API provided by the supplier's system, authentication information (such as a user ID and a password) necessary for order placement, and the order quantity and the product ID of the consumable item. The order-placing method may be determined by the product code of the consumable item, may be manually registered or set by the user, or may be automatically estimated based on data obtained by measuring the shape of the consumable item.

The “replacement history” is the history (for example, the date and time) of replacement of the consumable item. The “order placement history” is the history of order placement of the consumable item. The “order placement history” may include the date and time of order placement, supplier information, the order quantity, and the arrival date and time of an ordered consumable item.

The “handling method” is a method for detailed handling of the consumable item. For example, if the next state is “placing a replenishment order”, whether or not to automatically place an order, confirm with the user before placing an order, or confirm with the user only when the price of the consumable item is increased can be set. Similarly, if the next state is “disposal and replacement”, whether or not to automatically dispose of and replace the consumable item, or confirm with the user before disposing of and replacing the consumable item can be set. Note that the “handling method” may include “to be determined” indicating that handling of the consumable item, whose consumption level is determined, is to be confirmed with the user each time.

As described above, the consumable item information of each of the consumable items stored in the consumable item information storage unit 120 is associated with the above-described items, with the “consumable item ID” as a key. Note that the consumable item information of each of the consumable items is not required to include all of the above-described items (attributes or fields). For example, consumable item information of some consumable items may include some of the above-described items. Further, the consumable item information of each of the consumable items may include any other items in addition to the above-described items.

### <Consumable Item Inspecting Process>

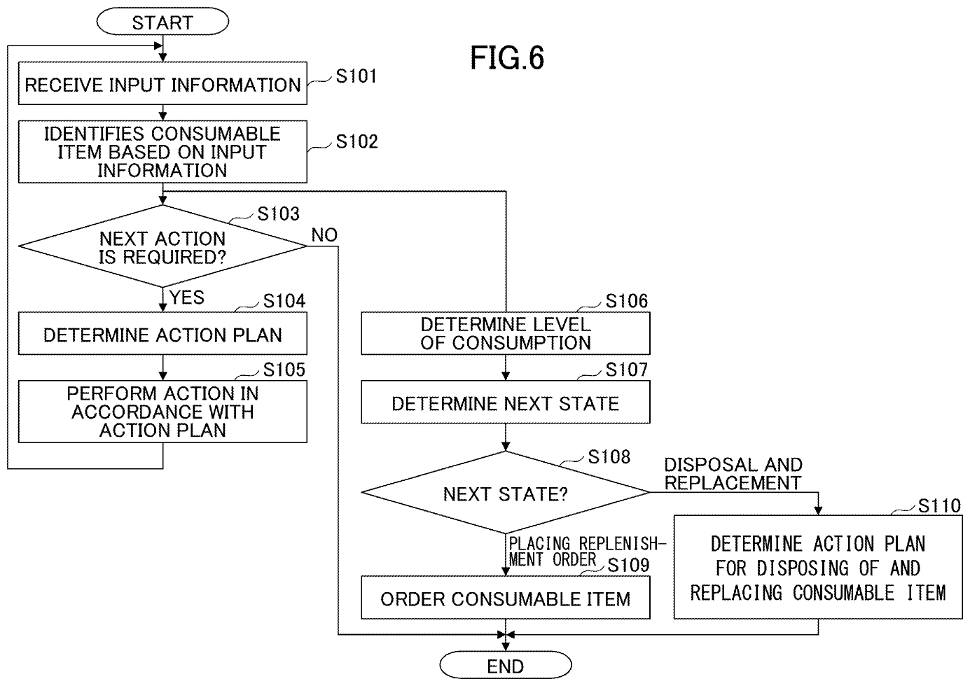

Next, a consumable item inspecting process will be described with reference to FIG. 6. FIG. 6 is a flowchart illustrating an example of a consumable item inspecting process according to an embodiment of the present disclosure. The consumable item inspecting process, which will be described below, may be performed in the background of the normal mode operation or as an interruption to the normal mode operation. Alternatively, if the consumables inspection robot 1 includes the above-described consumables inspection mode, the consumable item inspecting process may be performed as a process in consumables inspection mode. In such a case, the consumables inspection robot 1 may switch to the consumables inspection mode when the normal-mode operation or any other operation is not in the queue or when an explicit instruction is given by the user. For example, in consumables inspection mode, the consumables inspection robot 1 sequentially moves to the vicinity of each consumable item whose consumable item information is stored in the consumable item information storage unit 120, and captures each consumable item with the camera, (the moving and capturing being performed) in order of whichever uninspected consumable item is closest to the position of the consumables inspection robot 1 (or a consumable item to which the consumables inspection robot 1 can move in the shortest time).

First, the input control unit 111 receives various types of input information from the information acquisition device 20 (step S101).

Next, the consumable item identifying unit 112 identifies a consumable item (an object that may be a consumable item) based on the input information (in particular, an image captured by the camera) received by the input control unit 111 (in step S102). As a result, a consumable item ID and a consumable item class ID are output as identification results as described above.

For example, the identification of the consumable item may be performed by using a pre-trained SSD-based classifier or may be performed based on teaching data. Alternatively, the identification of the consumable item may be performed by a rule-based method, including detecting a barcode printed or attached to the consumable item or detecting characters on a package.

Further, the consumable item ID and the consumable item class ID may be identified separately. For example, the consumable item class ID may be identified by using a pre-trained machine learning model and an image captured by the camera to estimate the shape and the location of the consumable item. Then, the consumable item ID may be identified by referring to corresponding consumable item information stored in the consumable item information storage unit 120.

Further, for particularly important items (consumable items whose levels of consumption are desired to be particularly controlled), information for identifying the items as consumable items may be explicitly specified by the user.

Further, if items of the same type are used at a plurality of locations (for example, bars of soap of the same kind are used in a kitchen sink and in a bathroom sink, or a vegetable cutting board and a meat cutting board are used in a kitchen), while consumable item class IDs can be identified, it may be difficult to identify consumable item IDs. In such a case, the consumable item identifying unit 112 may observe or estimate the positional relationship between the items based on SLAM, and then identify the consumable item ID of each of the items (consumable items) by referring to corresponding consumable item information stored in the consumable item information storage unit 120.

Note that there may be a case where the consumable item identifying unit 112 finds (detects) a consumable item whose consumable item information is not registered (stored) in the consumable item information storage unit 120. In this case, the consumable item identifying unit 112 may automatically generate a consumable item ID and register consumable item information of the consumable item in the consumable item information storage unit 120. Alternatively, the information output unit 117 may output information, indicating that the unregistered consumable item is detected, to the user, and may register the consumable item in response to the user's instruction. At this time, the information output unit 117 may display the information on a user interface of the display of the consumables inspection robot 1, send the information to a terminal (such as a smartphone) of the user via email, or output sounds from the speaker of the consumables inspection robot 1. Alternatively, the information output unit 117 may output the information to a remote terminal operated by an operator via a network as an inquiry, instead of outputting the information to the user.

Next, the consumable item inspecting unit 110 performs steps as of step S103 and also performs steps as of step S106 for the consumable item identified in step S102 above.

Note that each piece of consumable item information stored in the consumable item information storage unit 120 may be stored in any table of a plurality of tables, based on tag information assigned to a corresponding consumable item in advance (alternatively, each piece of consumable item information may be simply associated with tag information assigned to a corresponding item in advance). The tag information may be information indicating whether the corresponding item is a consumable item, or may be information indicating the type of the item. Further, the tag information may be information indicating whether the item can be ordered without the user's permission.

For example, if such tag information (tag information indicating whether the item is a consumable item) is assigned in the example of S102 above, the consumable item identifying unit 112 may use the tag information included in the image of the item to determine whether the item is a consumable item. Further, in step S109 as will be described later, the tag information (tag information indicating whether the item can be ordered without the user's permission) assigned to the item (consumable item) may be used to determine whether to automatically order the consumable item or confirm with the user before ordering the consumable item.

In step S103, the planning unit 113 determines whether the next action is required. For example, if the consumable item is unable to be identified in step S102, the next action is determined to be required. Alternatively, if the consumable item class ID is identified, but the consumable item ID is unable to be identified, the next action is determined to be required. Alternatively, if another consumable item (whose level of consumption is yet to be determined) may be within the angle of view of the camera (that is, in the image captured by the camera), the next action is determined to be required. Alternatively, if a consumable item ID and a consumable item class ID are identified, but the level of consumption of the consumable item is difficult to be inspected (determined), the next action is determined to be required.

Examples in which the level of consumption of the consumable item is difficult to be inspected (determined) include a case in which the manipulator 32 needs to perform any operation with respect to the consumable item (such as measuring the weight of the consumable item by lifting the consumable item) when the level of consumption is unable to be visually inspected. In addition, the examples include a case in which the manipulator 32 needs to perform any operation with respect to the consumable item (such as moving the consumable item such that an expiration date printed on the consumable item faces the camera) when the expiration data is not included in the image of the consumable item.

Note that the planning unit 113 can determine whether the next action is required by ascertaining the current situation based on the identification results obtained in step S102, the input information received by the input control unit 111 (in particular, the image captured by the camera and a measurement value obtained by the sensor), and corresponding consumable item information stored in the consumable item information storage unit 120. For example, the planning unit 113 can estimate whether any other consumable item is located within the current angle of view, based on the distribution of consumable items included in the current angle of view and the number of consumable item IDs (identification results) of other consumable items identified in step S102. Further, the planning unit 113 can determine whether the level of consumption of the consumable item is difficult to be inspected based on the “consumption level determining method” included in the corresponding consumable item information.

If the planning unit 113 determines that the next action is not required, no action is performed. In this case, the consumable item inspecting process ends after confirming that steps S106 through S110 are performed for all consumable items identified in step S102. The consumables inspection robot 1 is then operated in normal mode (returns to normal mode).

Conversely, if the planning unit 113 determines that the next action is required, the planning unit 113 determines an action plan based on the input information received by the input control unit 111 (in particular, the image captured by the camera and the measurement value obtained by the sensor), and the corresponding consumable item information stored in the consumable item information storage unit 120 (step S104).

Various actions (task) are assumed to be included in the auction plan. Examples of such actions (task) are as follows.
Grasping, strike with a degree of force (such as hitting), and pressing on an item (consumable item) (when measuring the thickness of the remaining tissues as the level of consumption, for example).
Rotating and moving an item (causing the expiration date printed on, for example, the bottom of the item to face the camera) while grasping the item.
Controlling (the pan, tilt, zoom, and the like of) the camera, and controlling various sensors.
Moving another item in order to inspect an uninspected consumable item (for example, moving an object in the foreground if a part of an uninspected object in the background is hidden by the object in the foreground).
Moving objects not required for inspection to other places.
Moving objects back to the original locations.
Approaching an item, which is likely to be a consumable item, if the item is located from afar (for example, if the distance to the item is far and identifying the item from an image captured by the camera is difficult).

In addition to the above-described actions, the action plan includes any actions necessary to inspect (determine) the level of consumption of the consumable item.

Next, the input control unit 111 and the drive control unit 114 controls the information acquisition device 20 and the drive device 30 to perform the action in accordance with the action plan determined in step S104 (step S105). Accordingly, the action determined in step S104 is performed as the action of the consumables inspection robot 1.

Note that, if a consumable item registered in the consumable item information storage unit 120 is not identified (that is, not found) for a predetermined period of time by the consumable item identifying unit 112, consumable item information of the consumable item may be deleted from the consumable item information storage unit 120. Alternatively, assuming that the consumable item is consumed or disposed of, the information output unit 117 may output, to the user, information as to whether to place an order.

In step S106, the consumption level determining unit 115 refers to the consumable item information storage unit 120, identifies a consumption level determining method associated with the consumable item based on the identification results obtained by the consumable item identifying unit 112, and determines (inspects) the level of consumption of the consumable item by using the identified consumption level determining method. Note that the consumption level determining method is determined based on the consumable item class ID as described above.

For example, if the consumable item class ID indicates the “quantity-based consumable item”, the weight of a consumable item belonging to this consumable item class does not tend to change. In many cases, the level of the consumption of the consumable item can be determined from the appearance of the consumable item. Therefore, visual inspection may be performed on the consumable item. For visual inspection, an image classifier using a convolutional neural network (hereinafter simply referred to as a “CNN”) may be used. Further, if a consumable item is a light bulb or a fluorescent lamp, for example, the level of consumption may be determined (inspected) based on the flashing of or the amount of the light bulb or the fluorescent lamp. Further, for a consumable item that is consumed over time (such as a filter that needs to be replaced periodically), the level of consumption may be determined (inspected) based on the start date of use and the current date of the consumable item.

If the consumable item class ID indicates the “amount-based consumable item”, the level of the consumption of a consumable item can be determined or inspected based on the weight or appearance of the consumable item. For example, the level of the consumption of a transparent bottle containing a liquid (such as a bottled beverage) can be determined by measuring the liquid level from the appearance. Further, for example, in order to measure the remaining amount of rice in a rice storage container as the level of consumption, an image of the rice in the rice storage container may be captured by the camera. Alternatively, if the rice storage container has a transparent window, the level of consumption can be determined by capturing an image of the window portion. Further, for example, the level of consumption of a toilet roll in the holder can be determined from the appearance in a similar manner. In addition, for consumable items such as detergents and shampoos that are often contained in transparent bottles, and consumable items such as boxes of tissues, the remaining amount (level of consumption) of such a consumable item can be determined by grasping the consumable item and measuring the weight of the consumable item with the load sensor. If a container of a consumable item is equipped with a scale or a meter that indicates the remaining amount of the consumable item, the remaining amount (level of consumption) can be determined by capturing an image of the displayed remaining amount with the camera. In addition, the level of consumption may be measured by shaking a consumable item in the vicinity of the microphone and detecting a pattern of sounds. The sounds can be converted into a two-dimensional image in the form of a spectrum and processed by the CNN. In this manner, the remaining amount (level of consumption) can be determined as the estimated amount of the consumable item.

If the consumable item class ID indicates the “stock consumable item”, various determination methods can be used as well. In many cases, the level of consumption of a stock consumable item can be determined from the appearance by measuring the number of items remaining in stock. Therefore, visual inspection is preferably performed by capturing an image.

Next, in step S107, the next state determining unit 116 refers to the corresponding consumable item information stored in the consumable item information storage unit 120, and determines the next state of the consumable item (that is, an action to be taken for the consumable item) in accordance with the determination result (that is, the level of consumption of the consumable item), determined by the consumption level determining unit 115. As a method for determining the next state of the consumable item, the next state determining unit 116 may determine the next state based on the current level of consumption (that is, the level of consumption determined in step S106) and the corresponding consumable item information (such as the consumption level threshold, the consumption level history, and the order placement history) associated with the consumable item. However, for example, if information necessary for determining the next state is insufficient or a likelihood is insufficient, the information output unit 117 may output, to the user, information for confirming the handling of the next state.

An example of a method for determining whether to set “order placement” as the next state is described. First, the consumption level history and the replacement history of the consumable item information and the current level of consumption are used to predict the date and time when the consumable item is to be disposed of and replaced based on a technique such as regression analysis. In addition, the past order placement history, prior knowledge, and delivery date information obtained from the web API for the e-commerce site are used to estimate the time to be required for delivery of the consumable item. Then, the estimated time is multiplied by a predetermined factor of safety (the factor of safety may be defined by the user) to obtain a date and time. If the obtained date and time is later than the predicted date and time when the consumable item is to be disposed of and replaced, “placing a replenishment order” is determined as the next state.

Conversely, if there is a stock that can be replaced with the consumable item, and the level of consumption of the consumable item falls below the threshold, “disposal and replacement” is determined as the next state.

If the consumable item is a medicine, food, or a safety product such as a fire extinguisher, there may be a time-based standard for the level of consumption, such as the expiration date, the best before date, or the shelf date. In this case, if the level of consumption falls below the threshold (for example, one month before the expiration date), the next state (“placing a replenishment order” and/or “disposal and replacement”) may be uniquely determined.

Next, in step S108, the consumable item inspecting unit 110 determines the next step based on the next state determined in step S107 above. If the next state is “placing a replenishment order”, step S109 is performed as will be described below, and if the next state is “disposal and replacement”, step S110 is performed as will be described below. If the next state is both “placing a replenishment order” and “disposal and replacement”, both steps S109 and S110 are performed.

In step S109, if the next state determined by the next state determining unit 116 is “placing a replenishment order”, the order-placing unit 118 orders a new consumable item, which is the same as the currently-used consumable item, from the predetermined supplier (such as the e-commerce site). At this time, the order-placing unit 118 orders the new consumable item from the predetermined supplier by referring to the order-placing method included in the consumable item information of the currently-used consumable item. However, the consumable item that is the same as the currently-used consumable item is not necessarily ordered. For example, if prior confirmation or approval is obtained from the user, an item related to the consumable item (for example, an item that is determined to be substitutable for the consumable item based on the consumable item class and the like of the consumable item information stored in the consumable item information storage unit 120, or an item of the same type that is similar to the consumable item and recommended at the e-commerce site) may be ordered. Further, if there is an item recommended to the user (for example, offered at a lower cost, having superior functions, or recommended by a recommender function or an advertising function), the purchase of the item may be suggested to the user.

Note that the next state “placing a replenishment order” is cleared when an ordered product (consumable item) arrives. For example, the arrival of the product may be detected based on the web API for the e-commerce site, or may be detected when the ordered product is placed at a predetermined location.

In step S110, if the next state is “disposal and replacement”, the planning unit 113 determines an action plan for disposing of and replacing the consumable item. In accordance with the action plan, the input control unit 111 and the drive control unit 114 control the information acquisition device 20 and the drive device 30 to dispose of and replace the consumable item. When the disposal and the replacement of the consumable item are completed, the replacement date and time of the consumable item are recorded in the replacement history of the consumable item information of the consumable item. At this time, the start date of use of the consumable item is updated, and if the consumable item has an expiration date, the expiration date is updated. The next state “disposal and replacement” is cleared when the disposal and replacement of the consumable item is completed.

As described above, the consumables inspection robot 1 according to the embodiment of the present disclosure can inspect the levels of consumption of consumable items in a predetermined area in a home while autonomously moving, and can order (supply), dispose of, and replace the consumable items in accordance with the inspection results. Accordingly, the consumables inspection robot 1 according to the embodiment of the present disclosure can reduce the necessity for the user to replace, dispose of, and order various consumable items used or consumed at home, in an office, or in a factory. As a result, work related to the management of consumable items can be reduced.

In addition, the consumables inspection robot 1 according to the embodiment of the present disclosure identifies a consumable item and determines the level of consumption of the consumable item based on input information from the information acquisition device 20 such as the camera and the sensor. Accordingly, the consumables inspection robot 1 can inspect the level of consumption of the consumable item without attaching a sensor or a tag to the consumable item.

In the above-described the embodiments, the single consumables inspection robot 1 inspects the levels of consumption of consumable items. However, a plurality of consumables inspection robots 1 may inspect the levels of consumption of consumable items while working together and sharing information with each other. Accordingly, the levels of consumption of consumable items in a relatively large area such as a factory or an office can be efficiently inspected.

In the above-described embodiments, the movable consumables inspection robot 1 including the autonomous moving device and the information acquisition device 20, that is, the information acquisition device 20 is movable, has been described. Because the information acquisition device 20 is movable, the information acquisition device 20 can be preferably utilized at home where a large number of items are randomly placed at various locations without definite regularity, unlike factories and the like. In addition, because the moving device can approach an item, the item can be grasped, and information of the item can be thus appropriately acquired. Further, inspections of consumable items can be performed in places where privacy and confidentiality are generally considered to be important, such as homes, companies, hotel rooms, toilets, and bathrooms, without causing the users of the places to feel uneasy. Preferably, such inspections are performed when there is no user or a small number of users from the viewpoint of protection of privacy and confidentiality; however, the present disclosure is not limited thereto. Further, a predetermined action, including a physical operation such as supplying a consumable item, is performed at a location by the movable inspection apparatus (robot), thus allowing the user to comfortably use the location without being overly conscious of the inspection apparatus. In addition, in homes and similar environments, information necessary to determine the level of consumption of an item might be located in a blind spot (such as the side of the item opposite to the camera or the bottom of the item) where the camera is unable to capture an image of the information. However, in the above-described embodiments, because the consumables inspection robot 1 includes the operation device capable of physically manipulating the item, the level of consumption of the item can be appropriately determined.

Further, in the above-described embodiments, a consumable item is identified and the level of consumption is determined by the consumables inspection robot 1; however, the consumables inspection robot 1 may transmit input information, received from the information acquisition device 20, to a server via a network, and a consumable item may be identified and the level of consumption may be determined on the server.

Further, in the above-described embodiments, the consumables inspection robot 1 acquires information of all items. However, the present disclosure is not limited thereto. For example, a fixed camera installed in a place may acquire information for identifying items, and the movable consumables inspection robot 1 may acquire information related to the levels of consumption of the items.

Further, in the above-described embodiments, the identification of an item based on information acquired by the information acquisition device 20, is performed separately from the determination of the level of consumption of the item; however, the present disclosure is not limited thereto. That is, the identification of an item and the determination of the level of consumption can be performed at the same time (that is by one method or in one process). This can be achieved by a pre-trained model that is trained to not only identify an item but also determine the level of consumption.

Further, various suggestions or advertisements may be provided to the user of the inspection apparatus or to third parties in accordance with the level of consumption. For example, if the level of consumption of a certain medicine is low, it is considered that the medicine is not taken correctly, and a notification or a suggestion for providing medication guidance may be sent to the user, a third-party physician, or a medical institution such as a pharmacy. In addition, if the level of consumption of a certain food is high, it is considered that the food is the user's favorite, and the purchase of foods related to this food may be suggested to the user. That is, according to the present disclosure, various suggestions for items can be made based on the actual levels of consumption of items.

Further, in the above-described embodiments, the inspection apparatus determines the level of consumption of an item based on the consumable item class or the consumable item class ID of the item, rather than determining the level of consumption by simply comparing the initial state of the item (not consumed) to the current state. Accordingly, even if an already-consumed item (such as a partly-consumed bottle of a beverage or a second-hand piece of furniture) is detected by the inspection apparatus, the level of consumption of the item can be appropriately determined.

Further, items are not limited to consumable items as described above, and may be items (durable goods) that are ordered relatively less frequently. That is, the level of consumption of a durable good can be inspected, and an action can be taken for the durable good in accordance with the level of consumption. For example, the inspection apparatus can detect a defect (a type of consumption) in which a wood screw of a handle of clothing storage furniture is loose. In this case, the inspection apparatus may take an action to request a repair company to fix the furniture or to fix the furniture by the inspection apparatus (robot) itself. Further, the inspection apparatus can inspect the levels of consumption of furniture such as a couch and a curtain (for example, spring deterioration and fabric stains), and the levels of consumption of fittings (for example, a leak in the roof).

Further, the present invention is not limited to the particulars of the above-described embodiments, and various variations and modifications may be made without departing from the scope of the present disclosure.

What is claimed is:

1. An inspection apparatus comprising:
one or more memories; and
one or more processors,
wherein the one or more processors are configured to
identify a first item as a target whose level of consumption is to be observed, and
control a drive device to make the level of consumption of the first item, identified as the target, observable by an information acquisition device that observes the level of consumption of the target.

2. The inspection apparatus according to claim 1, wherein the one or more processors are configured to make a determination as to whether an action is to be performed to make the level of consumption of the first item, identified as the target, observable by the information acquisition device, and
control the drive device to perform the action in response to the determination.

3. The inspection apparatus according to claim 1, wherein the one or more processors are configured to control the drive device to perform one or more of grasping the first item, striking the first item with a degree of force, and pressing on the first item, such that the level of consumption of the first item is observed by the information acquisition device.

4. The inspection apparatus according to claim 1, wherein the one or more processors are configured to control the drive device to perform one or more of rotating the first item, moving the first item, and orienting the first item to face the information acquisition device while grasping the first item, such that the level of consumption of the first item is observed by the information acquisition device.

5. The inspection apparatus according to claim 1, wherein the one or more processors are configured to control the drive device to drive a mechanism of the information acquisition device, such that the level of consumption of the first item is observed by the information acquisition device.

6. The inspection apparatus according to claim 1, wherein the one or more processors are configured to control the drive device to move a second item that is different from the first item identified as the target, such that the level of consumption of the first item is observed by the information acquisition device.

7. The inspection apparatus according to claim 1, wherein the one or more processors are configured to control the drive device to cause the information acquisition device to approach the first item, such that the level of consumption of the first item is observed by the information acquisition device.

8. The inspection apparatus according to claim 1, further comprising a moving device configured to be driven by the drive device and cause the information acquisition device to be movable.

9. The inspection apparatus according to claim 1, wherein the information acquisition device includes a plurality of information acquisition devices configured to acquire information,
the information acquired by the plurality of information acquisition devices includes an image obtained by capturing the first item by a camera and a measurement value obtained by measuring the first item by a sensor, and
the one or more processors are configured to identify, based on the image, the first item as the target whose level of consumption is to be observed, and observe the level of consumption of the first item based on the measurement value.

10. The inspection apparatus according to claim 1, further comprising a manipulator configured to physically manipulate the first item,
wherein the one or more processors are configured to acquire information from the information acquisition device by causing the manipulator to manipulate the first item identified as the target, and observe the level of consumption of the first item based on the information acquired from the information acquisition device.

11. The inspection apparatus according to claim 10, wherein the one or more processors are configured to determine a manipulation task of the manipulator with respect to the first item identified as the target whose level of consumption is to be observed, and
the manipulator physically manipulates the first item based on the determined manipulation task.

12. The inspection apparatus according to claim 1, wherein the one or more processors are configured to take a predetermined action for the first item based on the observed level of consumption of the first item.

13. The inspection apparatus according to claim 12, wherein the predetermined action is at least one of replenishment, order placement, recommendation, disposal, or replacement.

14. The inspection apparatus according to claim 1, wherein the inspection apparatus is a mobile robot configured to move in a home.

15. The inspection apparatus according to claim 14, wherein the information acquisition device is a camera configured to capture an image, and
the inspection apparatus is configured to observe the level of consumption of the consumable item by analyzing the image captured by the camera while moving around in the home.

16. The inspection apparatus according to claim 14, wherein the mobile robot is configured to transfer a predetermined item from a first location to a second location in the home.

17. The inspection apparatus according to claim 16, wherein the one or more processors are configured to perform one or both of
controlling the drive device to move an obstacle aside when observing the level of consumption of the first item, and
controlling the drive device to move the first item to a position where the level of consumption of the first item is observable when observing the level of consumption of the first item.

18. The inspection apparatus according to claim 1, further comprising the information acquisition device and the drive device.

19. An inspection apparatus comprising:
at least one information acquisition device configured to be movable and acquire information related to an item; and
at least one processor configured to:
identify, based on the information acquired by the information acquisition device, whether the item is a target whose level of consumption is to be determined; and
determine the level of consumption of the item based on the information acquired by the information acquisition device, in response to the item being identified as the target whose level of consumption is to be determined.

20. A method for observing a level of consumption of a consumable item, the method comprising:
searching an environment for a target whose level of consumption is to be observed;
identifying, based on the search, a first item as the target whose level of consumption is to be observed; and
controlling a drive device to make the level of consumption of the first item, identified as the target, observable by an information acquisition device that observes the level of consumption of the target.
